(19) United States
(12) Patent Application Publication
(10) Pub. No.: US 2026/0017530 A1
(43) Pub. Date: Jan. 15, 2026

(54) Invertible-Reasoning Policy and Reverse Dynamics for Causal Reinforcement Learning

(71) Applicant: CCNets, Inc., El Dorado Hills, CA (US)

(72) Inventor: Jun Ho PARK, Gyeonggi-do (KR)

(21) Appl. No.: 19/327,623

(22) Filed: Sep. 12, 2025

Related U.S. Application Data
(63) Continuation of application No. PCT/KR2023/011170, filed on Jul. 31, 2023.

(30) Foreign Application Priority Data
Mar. 17, 2023 (KR) 10-2023-0035116
May 8, 2023 (KR) 10-2023-0058998
Jul. 18, 2023 (KR) 10-2023-009285

(51) Int. Cl. G06N 3/092; G06N 3/044

(52) U.S. Cl. CPC G06N 3/092; G06N 3/044

(57) ABSTRACT

Disclosed herein is the framework for Causal Reinforcement Learning which combines Causal Cooperative Networks with the Actor-Critic algorithm, introducing reverse dynamics, and invertible-reasoning policy within the framework to enable bidirectional transitions while maximizing accumulative rewards. The framework involves a redesigned Critic and Actor, as well as a newly developed Reverse-environment network. During the iterative training and exploration phases, the cooperative network learns a policy that identifies actions capable of reversing a future state back to its prior state, through the reverse-environment network. It allows agents to consider the consequences of their actions, which facilitates deeper decision-making and exploration strategies.

### RELATED APPLICATIONS

This application is a continuation of International Application PCT/KR2023/011170 filed on Jul. 31, 2023, which claims the benefit of Korean Patent Applications KR 10-2023-0035116 filed on Mar. 17, 2023, KR 10-2023-0058998 filed on May 8, 2023, and KR 10-2023-009285 filed on Jul. 18, 2023, all of the aforementioned applications are incorporated herein by reference.

### TECHNICAL FIELD

The present disclosure is a novel reinforcement learning approach that incorporates a Reverse-environment network into the Actor-Critic framework within a cooperative learning architecture.

### BACKGROUND ART

Reinforcement Learning (RL) has emerged as a powerful paradigm for decision-making in uncertain environments, enabling agents to learn optimal policies through trial and error. However, traditional RL algorithms face limitations, such as sample inefficiency and lack of interpretability. This is mainly due to their primary focus on learning policies and value functions in order to maximize accumulated rewards without explicitly considering the underlying causes and effects that govern state transitions in environments. In this invention, we introduce Causal Cooperative Nets (CCNets) which is redesigned for RL architecture that harnesses the interdependencies among environment variables to address these challenges and enhance learning efficiency.

Inspired by Judea Pearl's “ladder of causation” theory, which encompasses association, intervention, and counterfactual concepts, CCNets incorporate causality into the RL process to enable more robust and efficient learning algorithms. By doing so, we aim to improve exploration, training, and decision-making in RL by uncovering causal relationships between state, action, and accumulated rewards.

CCNets for RL involve a redesigned Critic and Actor, as well as a newly developed Reverse-environment network. These components work in tandem to facilitate a more deterministic approach to RL, capitalizing on the insights through modeling a reverse direction of state transition. We present the implementation of both standard and variant training algorithms using the PyTorch deep learning framework, showcasing the architecture of CCNets and their ability to overcome the limitations of traditional RL algorithms. This leads to improved performance across a variety of problem domains.

In the introduction to causal reinforcement learning, the future state is considered as a cause while the present state is regarded as an effect. By reversing the usual understanding of cause and effect explaining how events occur over time, this approach focuses on discovering causal relationships between actions and events in environments. As we decide optimal actions in the current state wishing a specific goal, the range of choices leading to that outcome narrows over time. Each time action has been taken, available options to achieve the goal gets fewer and fewer. If the future goal is set decisively in the present state, it would require your inevitable decisions that should be done in the present. Consequently, the future goals are understood to be the cause of our decisions that results in the present.

### Technical Problem

The present disclosure has been devised to solve the problems of the technology as described above, and the objectives of the present disclosure are as follows.

To introduce a method for agents to grasp an invertible-reasoning policy, which not only enhances their decision-making strategies but also increases the explainability of their actions.

To offer a method for agents to understand the environment dynamics by learning its reverse mechanism, thereby empowering them to simulate transitions within their environment.

To propose a method that uses the value function to regulate either the invertible policy or the reverse dynamics, indicating its integral role in bidirectional transition.

Objectives to be achieved in the present disclosure are not limited to those mentioned above, and other objectives of the present disclosure will become apparent to those of ordinary skill in the art from the embodiments of the present disclosure described below.

### Technical Solution

To achieve these objects and other advantages and in accordance with the purpose of the present disclosure, provided herein is a method for reinforcement learning of neural networks comprising a cooperative network configured to receive a sample of transition data, consisting of a state, action, reward, and the next state of an agent within an environment, and to learn a policy and value function that control a transition from a future state to its prior state, implemented through neural networks of a Critic, an Actor, and a Reverse-environment, wherein the Critic estimates a value of a sampled state and transmits the estimated value to the Actor and Reverse-environment, the Actor infers an action, from the sampled state and the estimated value, and transmits the inferred action to the Reverse-environment, and the Reverse-environment outputs a state that is recurred, from the sampled next state based on the inferred action and the estimated value, and outputs a state that is reversed from the sampled next state based on a sampled action and the estimated value, wherein costs associated with the forward, reverse, and recurrent transitions, between the sampled state and the next state, are calculated based on a discrepancy among the sampled state, the reversed state, and the recurred state, and wherein an error within the cooperative network is derived from a combination of the forward, reverse, and recurrent costs.

According to one embodiment of the present disclosure, the transition data is obtained through an exploration of the agent within the environment, and the actor determines an action for the agent, based on the current state and a value estimate received from the critic.

According to one embodiment of the present disclosure, the forward cost is calculated based on a discrepancy between the recurred state to the reversed state, the reverse cost is calculated based on a discrepancy between the reversed state to the sampled state, and the recurrent cost is calculated based on a discrepancy between the recurred state to the sampled state.

According to one embodiment of the present disclosure, the forward cost is associated with a critic error and/or an actor error in the cooperative network, the reverse cost is associated with a critic error and/or a reverse-environment error in the cooperative network, and the recurrent cost is associated with an actor error and/or a reverse-environment error in the cooperative network.

According to one embodiment of the present disclosure, the cooperative critic error is derived from a difference between the sum of the forward and reverse costs, and the recurrent cost, and the cooperative actor error is derived from a difference between the sum of the recurrent and forward costs, and the reverse cost, and the cooperative reverse-environment error is derived from a difference between the sum of the reverse and recurrent costs, and the forward cost.

According to one embodiment of the present disclosure, the value difference is calculated as the difference between the expected sum of rewards and the estimated value.

According to one embodiment of the present disclosure, the expected sum of rewards is computed based on a value estimate of the next state and the sampled reward.

According to one embodiment of the present disclosure, the value estimate of the next state is determined by a target network of the critic network and the target network is a slower-updating copy of the critic network.

According to one embodiment of the present disclosure, the value function error is derived by minimizing the value difference.

According to one embodiment of the present disclosure, Mean Squared Error (MSE) is employed to minimize the value difference, which is the difference between the expected sum of rewards and the estimated value.

According to one embodiment of the present disclosure, the critic loss is calculated as the sum of the value function error and the cooperative critic error.

According to one embodiment of the present disclosure, the backpropagation of the critic loss computes gradients of the loss function with respect to the parameters of the critic network without being involved in adjusting the actor or the reverse-environment; and the parameters of the critic network are adjusted based on the calculated gradients.

According to one embodiment of the present disclosure, the backpropagation of the cooperative critic error and the value function error computes, respectively, gradients of the error functions with respect to the parameters of the critic network without being involved in adjusting the actor or the reverse-environment, and the parameters of the critic network are adjusted based on the calculated gradients.

According to one embodiment of the present disclosure, the value difference is referred to as the advantage, and the actor loss is calculated by multiplying the advantage with the cooperative actor error.

According to one embodiment of the present disclosure, the backpropagation of the actor loss computes gradients of the loss function with respect to the parameters of the actor network without being involved in adjusting the reverse-environment, and the parameters of the actor network are adjusted based on the calculated gradients.

According to one embodiment of the present disclosure, the backpropagation of the cooperative reverse-environment error computes gradients of the error function with respect to the parameters of the reverse-environment, and the parameters of the reverse-environment network are adjusted based on the calculated gradients.

### Advantageous Effects

According to the embodiments of the present disclosure, the following effects may be expected.

First, by introducing a method for agents to grasp an invertible-reasoning policy, their decision-making strategies can be enhanced, and the explainability of their actions can be improved.

Second, the method enables agents to understand the dynamics of the environment by learning its reverse mechanism, thereby allowing them to simulate transitions within their environment and enhance their understanding of the environment.

Third, by proposing a method to regulate either the invertible policy or the reverse dynamics using the value function, it enables the understanding of its pivotal role in bidirectional transition.

Effects that can be obtained are not limited to the effects mentioned above, and other effects not mentioned will be clearly derived and understood by those of ordinary skill in the art from the embodiments of the present disclosure made known below. In other words, those of ordinary skill in the art will be able to clearly understand the unintended effects that can be achieved by practicing the present disclosure from the following detailed description.

### DESCRIPTION OF DRAWINGS

Conceptual diagrams are illustrated as follows:

FIG. 1—Illustrates a directed graph representing the dynamics in a RL environment, showing a forward transition from the current state to the next state over time.

FIG. 2—Illustrates a causal graph representing the reverse-dynamics in a RL environment, showing reverse transitions from the next state back to the current state, implemented through a neural network.

FIG. 3—Illustrates a policy-value feedback loop in reinforcement learning.

FIG. 4—Illustrates a value estimation for bidirectional transition control through an invertible-reasoning policy and reverse dynamics.

FIG. 5—Illustrates a value estimation for expected value and bidirectional transition control, converging towards the expected value.

FIG. 6—Illustrates an environment in reinforcement learning.

FIG. 7—Illustrates an Actor, A Critic, and Reverse-environment networks.

FIG. 8—Illustrates data flows through Actor, Critic, and Environment.

FIG. 9—Illustrates data flows through Actor, Critic, and Reverse-environment.

FIG. 10—Illustrates an exploration phase of the causal reinforcement learning.

FIG. 11—Illustrates a forward pass of the causal reinforcement learning.

FIG. 12—Illustrates a forward pass of the first variant causal reinforcement learning.

FIG. 13—Illustrates an implementation of the causal reinforcement learning.

FIG. 14—Illustrates an implementation of the first variant causal reinforcement learning.

FIG. 15—Illustrates an implementation of the second variant causal reinforcement learning.

FIG. 16—Illustrates an implementation of the third variant causal reinforcement learning.

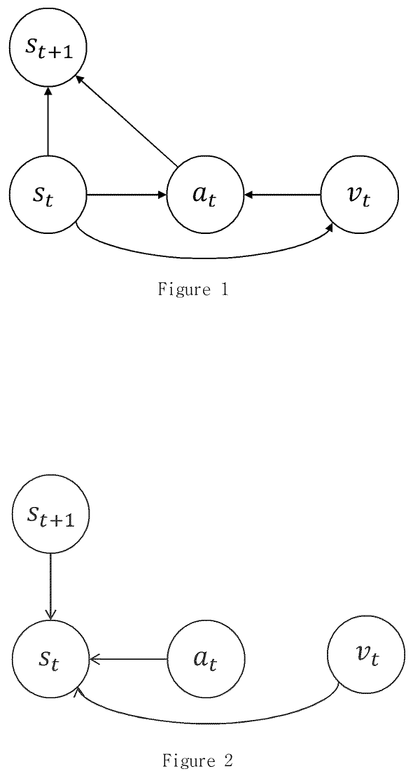

### MODE FOR INVENTION

In accordance with the embodiments described herein, a method for the reinforcement learning of neural networks may be executed by a controller incorporated within a server or terminal. This invention delineates and differentiates the neural networks of a Critic, an Actor, and a Reverse-environment, each characterized by the functions performed by the controller.

### 1. Causal Reinforcement Learning Framework

Causal reinforcement learning (causal RL) refers to the integration of causal learning introduced by the causal cooperative networks to the reinforcement learning (RL) to comprehend the underlying relationships between states, actions, and rewards. The causal RL Framework incorporates reverse dynamics, invertible-reasoning policy, and value estimation for the use in bidirectional transition. Learning causality can strengthen RL models, allowing agents to make better-informed decisions, optimize exploration strategies, and understand the environment's dynamics. This leads to enhanced training performance and generalization across a variety of tasks.

### 1. Reverse Dynamic Modeling

In a simple maze navigation example, a reinforcement learning agent utilizes the reverse dynamics of the environment to effectively navigate and make reward-maximizing decisions through repeatable state transitions. The agent starts at a position, takes an action (e.g., move up, down, left, or right), and then applies the reverse dynamics to perform an inverse action that undoes the effects of the previous action, returning it to the original position. By performing these reverse mechanisms, the agent can efficiently explore the maze and learn optimal strategies for solving it.

As shown in FIG. 2, Reverse dynamics is a unique approach in causal RL that aims to understand the causal relationships between states, actions, and sum of rewards within environments. Unlike conventional forward dynamics that observes the consequences of an agent's actions within environments, reverse dynamics operates backward by predicting reverse state of agents. In this approach, future states, upon performing a certain action, are traced back to their preceding state.

Implemented through a neural network in the CCNet architecture, the reverse dynamics network maps the connections between states and actions in reverse order of the time flow in environments. As shown in FIG. 2, the causal graph can be used to represent the directionality of the reverse dynamic process. The graph illustrates the causal relationship between states, actions, and the values in the environment, directing the next state, the action, and value as causes to the current state as an effect through reverse transition.

### 1. Invertible-Reasoning Policy

In a 2D maze navigation scenario, an Invertible-Reasoning Policy enables an agent to reach its goal effectively. It accomplishes this by incorporating the concept of invertibility into action reasoning. This policy allows the agent to select deterministic actions and consequently formulate an efficient path, thereby avoiding obstacles and dead ends.

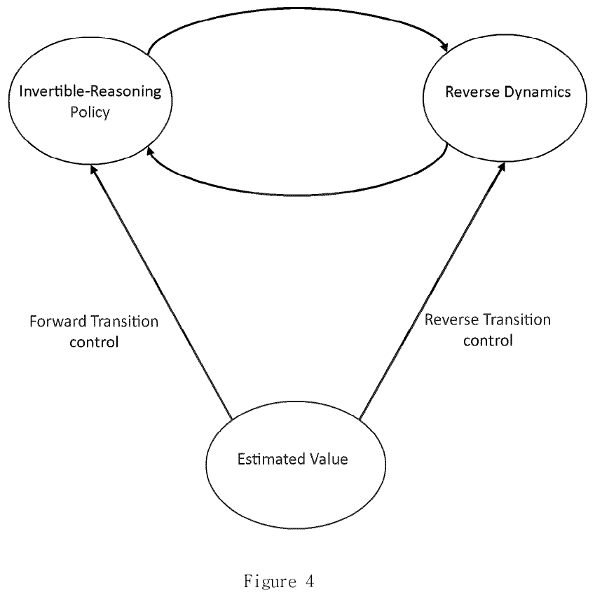

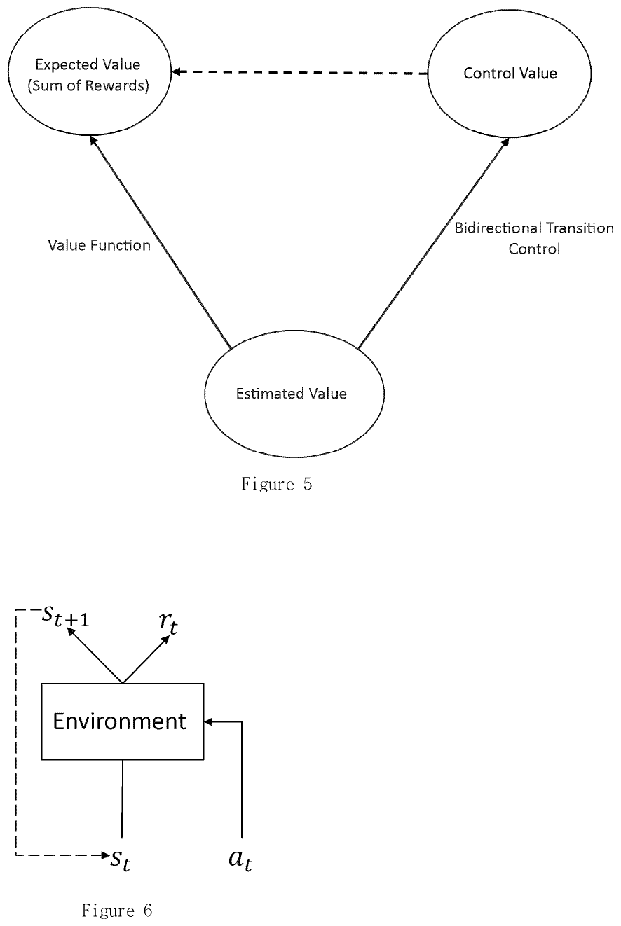

In FIG. 4, the invertible-reasoning policy, when given a state and its next state, can determine an action that, when undone from the next state, would revert it back to the original state. This policy identifies an action that could reverse the next state to the original one, through the reverse dynamics of the environment. It empowers the agent to consider the consequences of its actions, thereby leading to deep decision-making and exploration strategies. The Invertible-Reasoning Policy is learned through an iterative process that alternates between exploration and training phases, where the actor network adjusts its parameters and updates policy accordingly.

### 1. Value Estimation for Bidirectional Transition Control

In the context of a continuous 2D maze navigation scenario, an agent employs a strategy using a value estimate to control state transitions. This control value informs decisions and guides the agent's transitions, which include forward transitions from one state to the next based on the selected action. Also, the control value supports accurate reversion back to a previous state in line with the reverse environment dynamics. Through cooperative network training with the value function update, the control value progresses to converge with the expected sum of rewards.

As illustrated in FIG. 4, the control value derives an invertible-reasoning policy and reverse dynamics, indicating its integral role in bidirectional transition. The invertible-reasoning policy and reverse dynamics enable the agent to understand consequences of actions. The control value serves as a navigation parameter, directing the agent towards its goal and, when necessary, guiding it back, embodying a unified value necessary for the integrity of bidirectional transitions.

### Cooperative Network Components

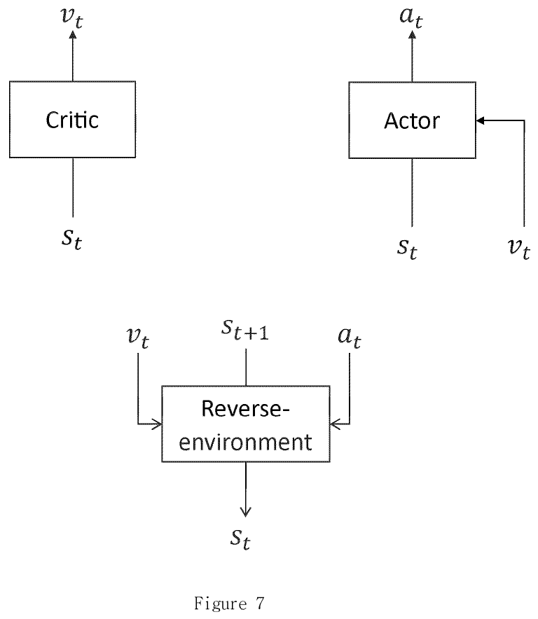

In the FIG. 7, the cooperative network for reinforcement learning consists of Critic, Actor, and Reverse-environment networks. Each network has a designated role in relation to variables in causal relationships, which allows for deterministic and interpretable decision-making. By undoing actions to revert states, the causal RL framework learns optimal actions that enables backtracking along the same path, even with repeated situations. As a result, the agent can make robust decisions in a manner that acknowledges the influences between variables, even in situations where direct experience is lacking.

A transition tuple consists of a state, action, reward, next state, and may optionally include a ‘done’ status.

A state vector is a vector representation of the state in the environment, which captures visible information. Each element of the state vector can represent a specific feature or attribute of observations in the environment. State vectors are acquired from the agent's observation during exploration, providing information gained in the environment.

An action vector is a vector representation of actions that agents executed in the environment. Each component in the action vector can correspond to a specific instruction for agents. Actions in the action space can be either continuous or discrete, depending on the environment and the agent's capabilities.

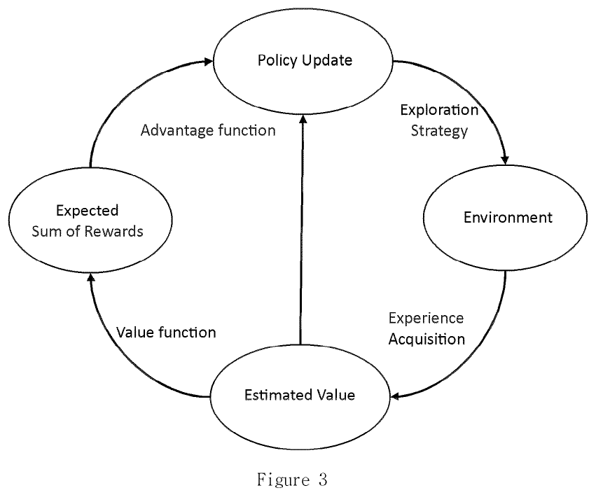

In FIG. 3, an expected value in reinforcement learning is a expectation of future rewards based on the agent's current state. It is updated over time, taking into account the reward received and the estimated value of the next state.

In FIG. 4, a control value for bidirectional transition acts as a target for the Critic network, which is for transitioning between states in both forward and reverse directions. It is target outcome that the Critic network aims to achieve through iterative learning and adjustments.

In FIG. 3˜5, an estimated value is a prediction provided by the Critic network. In the conventional RL, this value aims at estimating the expected value, which is the total sum or cumulative rewards, of a given state. In the context of causal RL, the estimated value also strives to predict the value required for controlling bidirectional transitions. Although the expected value and the control value for bidirectional transitions might initially differ, the control value progressively aligns closer to the expected value as the estimated value refines to represent both. However, since the control value is a latent value, it primarily learns the explicit value representation, that is, the expected value through the iterative learning process with value function update.

### 1. Critic Network

The critic network is designed to evaluate a given state. It receives a state vector, derived from the agent's observation, as input and provides an estimate of the expected sum of rewards. Also, the estimated value is utilized for prediction of a value that control transitions, implemented through both the actor and the reverse-environment networks.

During the exploration phase, agents collect a transition sample by executing a policy of the Actor that receives an value estimate of the Crtic. In the training phase, the critic takes on the task of estimating the value of a sampled state. The value function is then adjusted to minimize the discrepancy between the estimated value and the expected sum of rewards. The Critic can be expressed as:

$$V ( S ) = Critic ( S )$$

where V(S) represents the estimation of the expected sum of rewards and the use of bidirectional transition from a given state, S.

### 1. Actor Network

The actor network determines an action for a given state, controlled by a value, in a forward transition that progresses the agent from the current state to the next state in the environment. During the training iteration, the control value becomes aligned with the expected value of the current state, which can be driven from the next state and its reward. In other words, the actor network infers an action that is worth for the initially given value for a forward transition, where the expected sum of rewards is acquired through the action's execution within the environments.

The actor network operates under two main phases-exploration and training. In the exploration phase, agents explore environments and collect experience. During the training phase, the actor updates its decision-making process based on the advantages in the sampled action of agents' experience. This iterative process of exploration and training promotes a policy in exploration and decision-making that earn higher rewards.

The Actor receives a state and a value as input, then it determines an action for an agent. For instance, the Actor receives the state vector S and estimated value vector V as input and determines an action. The Actor can be expressed as:

$$a ( S , V ) = Actor ( S , V ) ,$$

where a (S, V) is the action determined by the Actor for the state S and value V.

### 1. Reverse-Environment Network

The Reverse-environment network is designed to learn the reversed pattern of state transitions, thereby enabling the agent to understand the dynamics of the environment. It governs the transition from a future state back to its previous state, using a received action and a value for a transition control. During the training iteration, this control value becomes aligned with the expected value of the previous state, which can be derived either from value estimate of the previous state or from its subsequent state and the reward. In essence, the Reverse-environment network predicts a previous state that is predicts for the initially given value.

The Reverse-environment network functions primarily during the training phase. Throughout this phase, it refines its reverse-dynamics process based on the inferred action and the value estimate. The Reverse-environment network takes the next state S′, the action A, and the value V as input. It then predicts the initial state S, which corresponds to the state before the action A was executed, before the next state S′. The Reverse-environment can be expressed as:

$$S ( {S}^{′} , A , V ) = Reverse - environment ( {S}^{′} , A , V ) ,$$

where S (S′, A, V) represents the reverse-environment mapping from the next state S′, through the action A, and based on the value V, back to the initial state S.

### 1. Interactions Between Networks

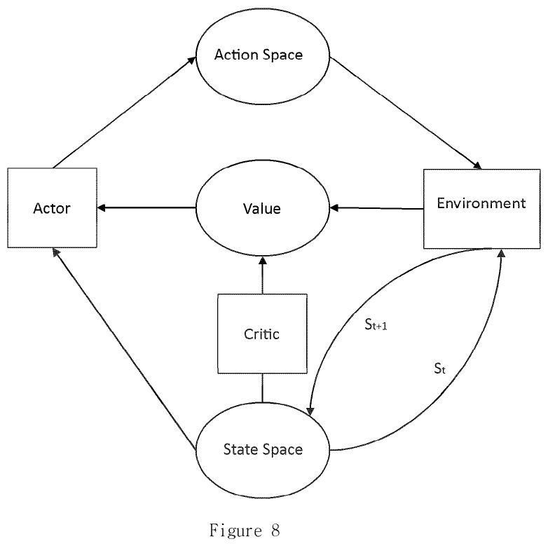

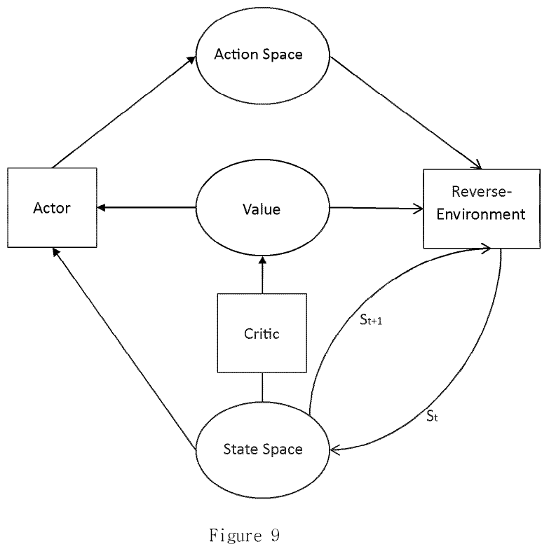

Regarding the FIG. 8˜9, the causal RL framework incorporates a synergistic learning process among the Critic, Actor, and Reverse-environment networks. These networks communicate through connected channels, enabling them to jointly learn relationships between variables in state transitions.

### Critic and Actor Interaction

As depicted in FIG. 3, the Critic and Actor work together to optimize the agent's decision-making process throughout the exploration and training phases. The Critic network estimates the expected value (or sum of rewards) and provides this information to the Actor, which then determines actions based on the Critic's estimations. In the iterative exploration and training process allows the Actor to refine its policy and increase the sum of rewards, while the Critic continues to improve its accuracy for value estimations.

The exploration accompanied with both the Critic and Actor indirectly contributes to enhancing the performance of the cooperative network in several aspects. The Actor network, controlled by this value estimate, makes decisions aimed at maximizing the accumulated rewards. During the training phase, the estimated value for the expected accumulated rewards also satisfies with value for bidirectional transitions. This goes through combination of the two errors, which represent to the value function and bidirectional transition control, formed in the Critic's loss function, which will be discussed more detail below.

Throughout the iterative process of the exploration and training, the Critic and Actor networks collaborate to estimate a value for the expected sum of rewards and bidirectional transition control. Together, the Critic and Actor networks contribute to the enhancement of value estimation, improving the invertible-reasoning policy, and maximizing accumulative rewards.

### Critic and Reverse-Environment Interaction

The interaction between the Critic and Reverse-environment facilitates learning about the underlying dynamics of the environment. The Critic provides a value estimate for a desired state and the Reverse-environment reverses the inputted state to the desired state based on the value estimate with a given action. This process helps the agent to understand the environment dynamics and learn how its actions affect state transitions in environments.

### Actor and Reverse-Environment Interaction

The Actor and Reverse-environment cooperatively learn the recurrence of states within a given value. The Actor infers an action for the current state using the provided value, while the Reverse-environment employs the same value to reverse a transition from the next state back to the original state. This interaction guides the agent's learning of actions that can generate a state looped back from the initial state, thereby performing reverse dynamics via recurrent state transition.

This process acts close to a reconstructive mechanism, such as an autoencoder in machine learning, enabling the agent to comprehend environment dynamics and identify its actions on state transitions. By attempting to revert the next state back to the original state using the inferred action and the estimated value, a verifiable bidirectional transition is established, reinforcing the learning in a recurrent manner.

### Learning Process

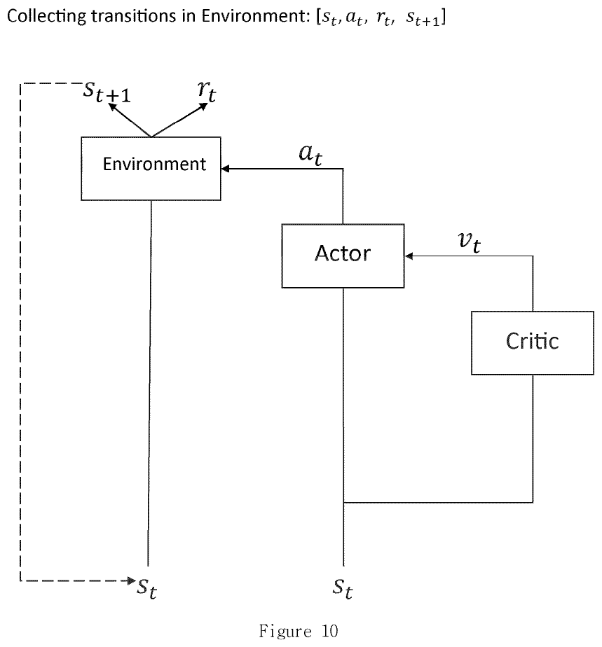

Regarding the FIG. 10˜12, in Causal Reinforcement Learning (Causal RL), the learning process involves several key steps. In the exploration phase, the agent interacts in the environment to gather experience data on states, actions, and rewards. In the training phase, cooperative neural networks employ forward passes, and measure transition costs to derive errors for each network. Loss functions combine the cooperative errors quantifying inaccuracies of networks with value function and advantage components that contribute to reinforcement learning. Then, the loss backpropagates to compute the gradient of the loss function and update the network's parameters.

### 1. Exploration Phase

Causal RL can adapt the off-policy training techniques. In the off-policy training, agents experiment with various actions across states, gaining experience that used for updates to neural networks. Experience data comprises a tuple containing state, action, reward, next state, and done representing the agent's transition with its environment. The experience is stored in a replay buffer, which enables the use of agents' past interactions with their environment during the training phase.

Regarding the FIG. 10, in the exploration phase, the actor and critic collaborate to execute policy with value estimation and collect experience data. During the training phase, this data is sampled to train the cooperative networks, allowing them to update the policy and value estimation based on the agents' past experiences in various environments.

### 1. Forward Pass

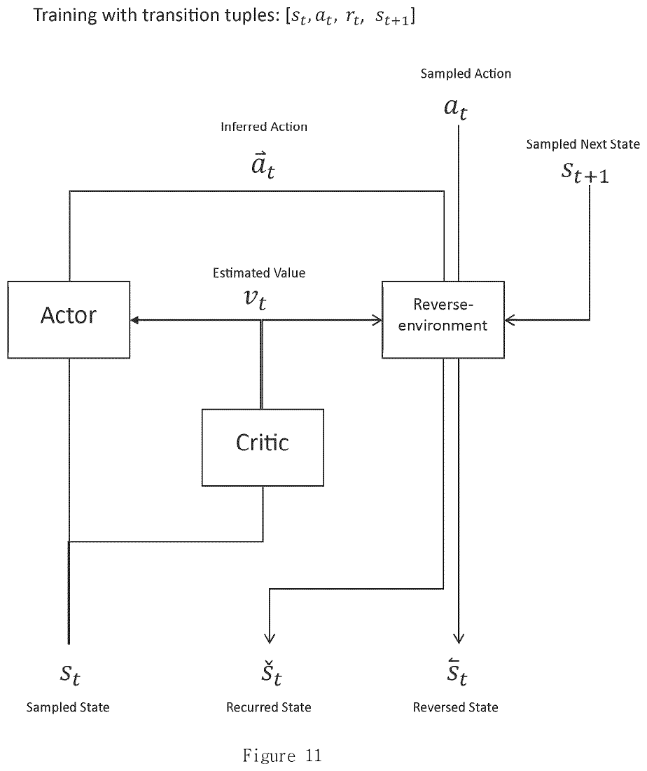

Regarding the FIG. 11, in the training phase, the forward pass involves processing the transition data through the Critic, Actor, and Reverse-environment networks. The forward pass process is described in detail, including the reception and transmission of signals between the networks and the input and output of cooperative networks.

The Critic, Actor, and Reverse-environment transfer information by outputs of the neural networks such as inferred actions from the Actor, estimated values from the Critic, and reversed and recurred states from the Reverse-environment, generating computational graphs for backpropagation. The forward pass through causal cooperative network for an input (or a sample) of transition comprising a tuple of state, action, reward, next state, and done as follows: Critic receives a state(s) from the agent's observation, estimates a value of the state, and transmits the estimated value (v_estimated) to both the Actor and Reverse-environment networks.

Actor receives the state(s) and the estimated value (v_estimated) from the Critic, infer an action, and transmits the inferred action (a_inferred) to the reverse-environment network.

Reverse-environment outputs a reversed state (s_reversed) from the next state (s′), action (a), and the estimated value (v_estimated), and
outputs a recurred state (s_recurred) from the next state (s′), the inferred action (a_inferred), and the estimated value (v_estimated).

In summary, during the forward pass, the critic takes a state (or a sampled state) as input and outputs an estimated value, which is then fed into the Actor and Reverse-environment. The Actor uses the estimated value to infer an action of the state. The Reverse-environment receives the next state (or sampled next state), an estimated value, an action (or sampled action) and outputs a reversed state. Also, the Reverse-environment receives the next state, estimated value, inferred action and outputs a recurred state.

### 1. Transition Costs

During the training phase, the cooperative network inputs transition tuples and outputs reversed and recurred states. The costs for forward, reverse, and recurrent transitions calculated by the input and output are used to compute errors in the cooperative network.

The forward cost originates from inaccuracies in signal propagation between the Critic and Actor, in forward transition, when determining actions from input states.

The reverse cost originates from inaccuracies in signal propagation between the Critic and Reverse-environment when reversing the sampled next state to the sampled state using the sampled action and the estimated value.

The recurrent cost originates from inaccuracies in signal propagation between the Actor and Reverse-environment when returning the sampled state through the inferred action.

$$transition cost = Cost function ( prediction parameter , target parameter )$$

A cost function is utilized to calculate a discrepancy between predicted state and target state. The function is applied as follows:

$$\begin{matrix}Forward cost = Cost function ( Recurred state , Reversed state ) \\ Reverse cost = Cost function ( Reversed state , Sampled state ) \\ Recurrent cost = Cost function ( Recurred state , Sampled state )\end{matrix}$$

These costs are represented as discrepancy between recurred, reversed, and sampled states. The transition costs can be defined using the absolute difference (L1) function:

$$\begin{matrix}Forward cost = \vert Recurred state - Reversed state \vert \\ Reverse cost = \vert Reversed state - Sampled state \vert \\ Recurrent cost = \vert Recurred state - Sampled state \vert\end{matrix}$$

The costs occurred in transitions can go through dimension reduction in the direction of layer or batch. To optimize backpropagation, the reversed state in the forward cost can be detached, along with detaching the estimated value inputted into the reverse-environment network when the network outputs a recurred state, preventing undesired backpropagation through the reversed state, which is used for calculating a forward cost.

Error backpropagation is initiated by the loss function, and it moves backward through the transition costs, computing gradients for the relevant neural networks, which are actor, critic, or reverse environment. The backpropagation process navigates through the computation graphs created during signal propagation, which are combinations of the three transition costs:

In relation to forward cost, gradients are calculated for the loss function concerning the parameters of the actor or critic as it moves through the computation graph.

In relation to reverse cost, gradients are calculated for the loss function concerning the parameters of the reverse-environment or critic as it moves through the computation graph.

In relation to recurrent cost, gradients are calculated for the loss function concerning the parameters of the actor or reverse environment, excluding the critic.

### 1. Cooperative Network Errors

Network errors in the cooperative network are respectively assigned for Critic, Actor, or Reverse-environment networks. They are derived from error functions, which calculate the difference between the sum of two transition costs and another relevant transition cost.

$$cooperative network error = Error function ( prediction parameter , target parameter )$$

Driven from transition costs, network errors represent the direct inaccuracies of the networks in forward, reverse, and recurrent transitions. They are calculated by applying an error function to each corresponding pair of prediction and target costs. The specific error functions for the three networks are:

$$cooperative critic error = Error function ( forward cost + reverse cost , recurrent cost )$$

$$cooperative actor error = Error function ( recurrent cost + forward cost , reverse cost )$$

$$cooperative reverse - environment error = Error function ( reverse cost + recurrent cost , forward cost )$$

Cooperative critic error is an error of Critic that occur during the value estimation of a sampled (or inputted) state for the bidirectional transition control. It is responsible for estimating a value, which has a latent value, needed for both forward transition and reverse transition within a given recurrent transition.

Cooperative actor error is an error of Actor that occurs during the prediction of an action for a sampled (or inputted) state with the estimated value. It is responsible for reasoning an action for a forward transition and a recurrent transition within a given reverse transition.

Cooperative reverse-environment error is an error of Reverse-environment that occurs during the generation of a current state from the sampled (or inputted) next state, action, and the estimated value. It is responsible for reverse transition and recurrent transition within a given forward transition. The terms cooperative reverse-environment error and cooperative reverse-environment loss, which will be introduced below, can be used interchangeably.

By minimizing the three network errors, the three networks can acquire the invertible-reasoning policy, reverse dynamics, and value estimation for bidirectional transition. These capabilities are visually presented in a causal graph, illustrating the underlying causal relationships between variables where the next state, action, and value act as causes, leading to the current state as the resulting effect.

### 1. Loss Functions

To comprehend loss functions in Causal Reinforcement Learning (causal RL), the Bellman equation can be referred. The Bellman equation is fundamental in reinforcement learning, as it calculates the expected sum of rewards of a state (V(s)) using the immediate reward (r) and the discounted value of the next state (γ*V (s′)). The Advantage function (A (s, a)) plays a crucial role in measuring the value of a specific action in a state compared to the average value of all possible actions in that state. This function, which is known as Temporal-difference (TD) error, is derived using the state value function (V(s)) from the Bellman equation.

$$Advantage ( s , a ) = ( r + γ * V ( {s}^{′} ) ) - V ( s )$$

On the other hand, a target network for the Critic can be utilized to improve stability in value estimation in causal RL. The target network is a copy of the Critic network with slower updates. It helps to provide steady goals for learning and lowers the chance of unexpected changes or repeat cycles during training.

The causal RL approach incorporates the causal learning into the traditional reinforcement learning methods. Loss functions for the critic and actor are redesigned based on network error derivation. In the context of causal RL, the Critic, Actor, and Reverse-environment losses can be defined accordingly.

$$\begin{matrix}Actor Loss = advantage * cooperative actor error \\ Critic Loss = value function error + cooperative critic error \\ Reverse - environment Loss = cooperative reverse - e nvironment error\end{matrix}$$

Wherein, the cooperative actor error, the cooperative critic error and the cooperative reverse-environment error are driven during the training of the cooperative network. To ensure the stability of the advantage scale, the use of a normalized advantage can serve as an alternative.

The Actor Loss calculated by multiplying the cooperative actor error with the advantage. The cooperative actor error indicates a causal learning element occurred in the cooperative network about determining actions, while the advantage is the conventional RL element regarding to Actor to Critic framework that drives agents to maximize the sum of rewards.

$$Actor Loss = advantage * cooperative actor error$$

By multiplying the cooperative actor error with the advantage, the actor loss can have either positive or negative values. The effect of the advantage, whether positive or negative, on the exploration and training agents as follows:

In a case of positive advantage, it indicates that an action's expected value exceeds the estimated value of a sampled state. It encourages the agent to explore more promising options and discover rewarding actions, ultimately enhancing its decision-making ability.

In a case of negative advantage, it indicates that an action's expected value falls below the estimated value of a sampled state. It discourages the agent from choosing suboptimal actions, promoting focused exploration of actions with a higher likelihood of resulting rewards.

By incorporating the advantage into the cooperative actor error, which is from the cooperative network, the actor loss helps the agent learn how the effects of their actions occur while maximizing their rewards. This approach incorporates the comprehension of cause-and-effect relationships into reinforcement learning. Consequently, the agent gains a deeper understanding of the environment and refines its decision-making process. By doing so, the agent is better equipped to prioritize actions that maximize cumulative rewards across a variety of situations, while considering the effects of their actions.

In backpropagation, the actor loss, which is the multiplication of the cooperative actor error and the advantage, may not modify the parameters necessary for computing the advantage. To achieve this, the computation graph of the advantage should be detached, preventing the actor loss from backpropagating through it.

In causal RL, the Critic loss is composed of two components: value function error and cooperative critic error. The value function error occurs in value estimation for the expected sum of rewards. The cooperative critic error occurs in the cooperative network training. By combining these components, the critic can learn a unified representation of values from both the reinforcement learning and causal learning aspects.

$$Critic Loss = value function error + cooperative critic error$$

Value function error is based on the discrepancy between the expected value and estimated value. It can be calculated by the Mean Squared Error (MSE) derived from the value difference between the expected value and the estimated value. On the other hand, cooperative critic error is derived from the cooperative network training and helps the critic to learn a value for a control needed by the Actor and Reverse-environment.

Critic Loss can be backprogated and the error gradient is computed with respect to the network's parameters to adjust them and minimize the loss. Backpropagation can be used to adjust parameters in Critic network. On the other hand, the value function error and the cooperative critic error are backpropagated separately. The error gradient for each of these two errors is computed with respect to the network's parameters. The accumulated gradients resulting from these separate backward passes are then used to minimize both errors.

To optimize the cooperative training process with the Actor network, the cooperative critic error can be formulated by multiplying max (advantage, 0) with the cooperative critic error. The resulting Critic Loss equation becomes: Critic Loss=value function error+max (advantage, 0)*cooperative critic error. This ensures synchronization in training with the Actor within the positive advantage range.

Alternatively, the cooperative critic error can be formulated by multiplying the advantage with the cooperative critic error. The resulting Critic Loss equation becomes: Critic Loss=value function error+advantage*cooperative critic error. This also ensures synchronization in training with the Actor within the positive advantage range.

However, when negative advantages occur, the cooperative critic error with the advantage can introduce noise effects to the Actor during the exploration phase, prompting the actor to make a wider range of decisions. The penalty encourages the Actor to explore various actions. Thus, the Critic in the causal RL algorithm can utilize penalties received during the model training instead of adding noise in the exploration phase, such as Gaussian noise used in the DDPG (Deterministic Deep Policy Gradient) algorithm. Consequently, the causal RL algorithm becomes less reliant on injecting stochasticity during exploration, which is typically required in the conventional RL algorithms. This results in the causal RL algorithm facing fewer challenges related to the exploration-exploitation trade-off, compared to the conventional counterparts.

The Reverse-environment loss indicates cooperative reverse-environment error. This loss function assists the Reverse-environment network in learning the reverse dynamics of the environment and understanding transitions within the dynamic system of environments. The terms cooperative reverse-environment error and cooperative reverse-environment loss can be used interchangeably.

$$Reverse - environment loss = cooperative reverse - environment error$$

To optimize the cooperative training process with the Actor, the reverse-environment loss can be formulated by multiplying max (advantage, 0) with the cooperative reverse-environment error. The resulting Reverse-environment Loss equation becomes: Reverse-environment Loss=max (advantage, 0)*Cooperative reverse-environment error. This ensures synchronization in training with the Actor within the positive advantage range.

### 1. Backpropagation

In the cooperative network training, the error gradient is computed with respect to the network's parameters to adjust them and minimize the loss. Backpropagation can be used to adjust parameters in Critic, Actor, and Reverse-environment. By computing the gradients of the loss function with respect to these parameters, model updates are performed. The backpropagation algorithm modifies the parameters to minimize the loss function for both positive and negative loss values. The actor, critic, and reverse-environment losses can be individually backpropagated to calculate the gradients of the neural network parameters with respect to their specific loss functions.

The advantage, when multiplied with the errors, may not be directly adjusted through backpropagation. For example, the advantage which is multiplied with the cooperative actor error (or Cooperative critic error, Cooperative reverse-environment error) may not be adjusted through backpropagation. Instead, the advantage is adjusted through the backpropagation of the value function error, which forms part of the critic loss.

Error backpropagation passes through the computation graphs created during forward passes, focusing on the network that is set to be the target. To prevent unnecessary adjustments to non-target networks, their parameters can be frozen during backpropagation. This allows the gradient computation to concentrate solely on the specific network without affecting the other networks. Alternatively, an approach that includes non-target networks in the path of both the prediction parameter and the target parameter of the loss function can be used, enabling multiple networks to learn, respectively.

The gradients for networks Critic, Actor, and Reverse-environment can be calculated using backpropagation. These networks strive to reduce forward, reverse, and recurrent costs. Through repeated training and updates, these costs may diminish or converge to a specific value, like zero. Similarly, the errors for the critic, actor, and reverse environment in the cooperative network, may also approach a particular value, such as zero, over time with iterative training and updates. The losses for Critic, Actor, and Reverse-environment, which represent the causal and reinforcement relationships among states, actions, and values, may also converge to a specific value, like zero, through continued training and updates.

### 1. Implementations

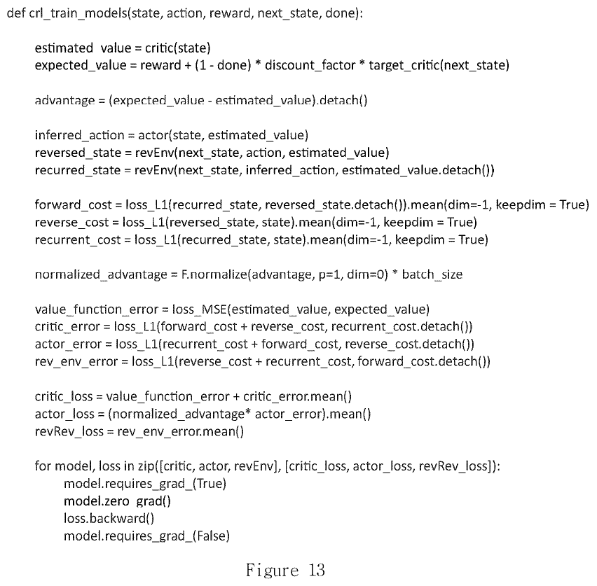

In FIG. 11, the causal RL training process is visually represented, while FIG. 13 provides an example of the training algorithm implemented using the PyTorch deep learning framework. The L1 function is named loss_L1, shown in FIG. 13-16 Causal RL implementation, and dimensionality reduction may not be applied to the L1 function to incorporate advantage or value function error into the Critic loss or the Actor loss.

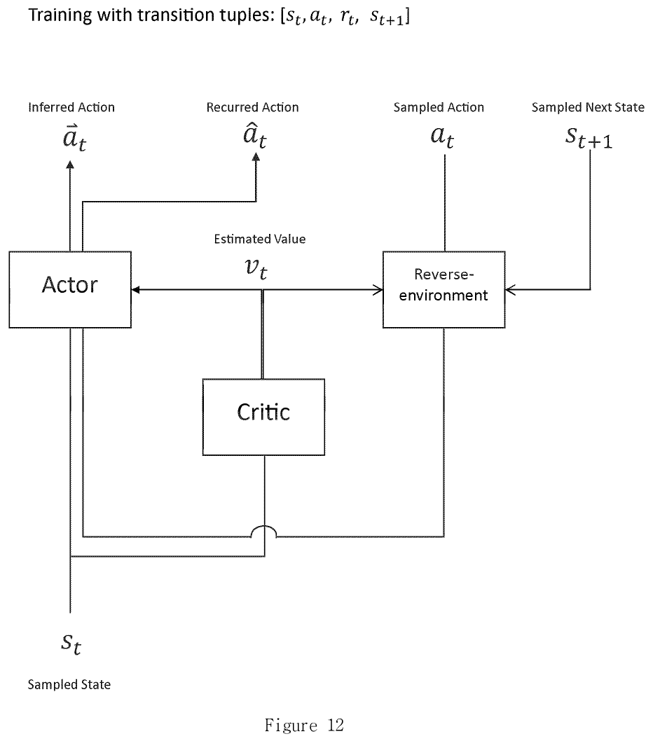

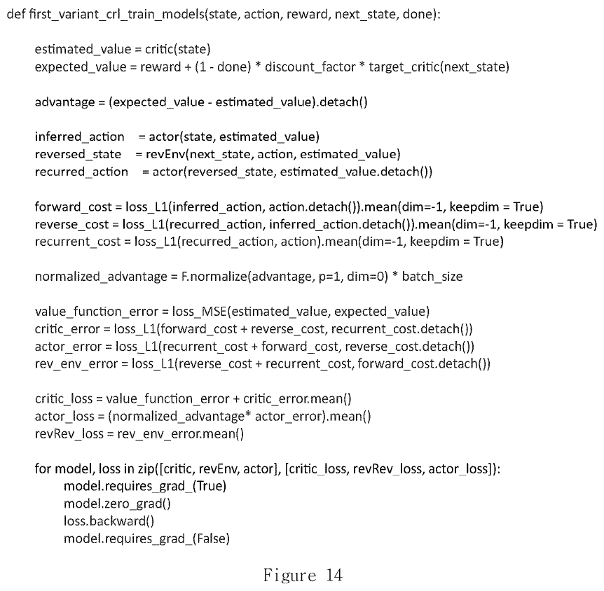

FIGS. 12 and 14 illustrate the introduction of the first variant of the causal reinforcement learning method. This version computes transitions and their associated costs using input and output actions. This corresponds to defining a recurrent transitioning pattern that starts from the cause, moves to the effect, and returns to the cause-indicative of the recurrence of the sampled action. In the first variant, the processes of the forward pass and transition cost calculations differ from the standard causal RL training algorithm. In the FIG. 12, The forward pass for the first variant of the training algorithm proceeds as follows:
the Critic estimates a value of a sampled state and transmits the estimated value to the Actor and Reverse-environment;
the Reverse-environment generates a state that is reversed from the sampled next state based on a sampled action and the estimated value;
the Actor outputs an action that is recurred from the reversed state and the estimated value, and
outputs an action that is inferred from the sampled state and the estimated value;

The training algorithm for this first variant uses a cost function to quantify the discrepancy between the predicted action and the target action. The implementation of the cost function is as follows:

$$\begin{matrix}forward cost = cost function ( inferred\_action , action ) \\ reverse cost = cost function ( recurred\_action , inferred\_action ) \\ recurrent cost = cost function ( recurred\_action , action )\end{matrix}$$

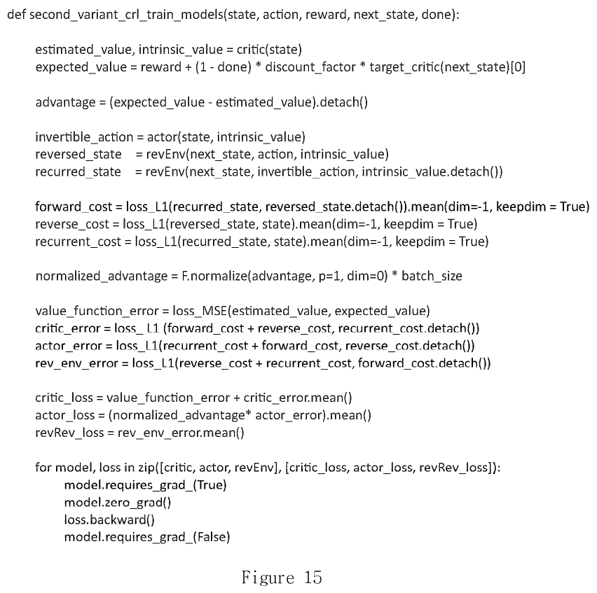

In FIG. 15, the second variant of the Causal RL is implemented. Critic network estimates a value represented by a latent vector in the latent value space. The Critic receives a state vector obtained from the agent's observation as input and predicts a value vector representing both intrinsic and extrinsic value of the state. The data distribution of the value vector corresponds to the intrinsic value information of the state. And the mean of the value vector corresponds to the extrsinsic value information of the state, which is the estimated value for the expected accumulated rewards. In the second variant, the process of the forward pass differs from the standard training algorithm. The Critic can be expressed as:

$$V ( S ) = Critic ( S ) ,$$

where V(S) is the value vector estimated by the Critic from the state S as input.
The extrinsic value of the vector is given by: E(V)
The intrinsic value of the vector is given by: Z(V)

In this context, the extrinsic value of the value vector represents an estimate for a sampled state. The forward pass in the second variant of the training algorithm proceeds as follows:

The Critic receives the sampled state(s) from the agent's observation, predicts a value vector, and then transmits a data distribution of that value vector (v_dist) to both the Actor and Reverse-environment networks.

Actor receives the sampled state(s) and the data distribution (v_dist) from the Critic and transmits an inferred action vector (a_inferred) to the Reverse-environment network.

Reverse-environment outputs a recurred state (s_recurred) from the sampled next state (s′), inferred action (a_inferred), and the data distribution (v_dist), and

outputs a reversed state (s_reversed) from the sampled next state (s′), sampled action (a), and the data distribution (v_dist).

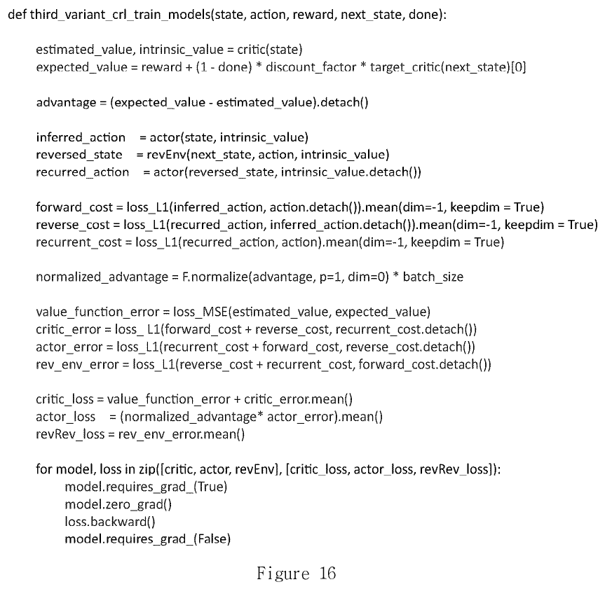

Regarding FIG. 16, on the other hand, the third variant of the Causal RL can be introduced by combining the first variant and the second variant of the Causal RL. Based on the first variant's training algorithm, the Critic network is designed to estimate the value vector that is related to the second variant algorithm. The forward pass for the third variant of the algorithm proceeds as follows:

Critic receives the sampled state(s) from the agent's observation, predicts a value vector, and then transmits a data distribution of that value vector (v_dist) to both the Actor and Reverse-environment networks.

Reverse-environment generates a reversed state (s_reversed) from the sampled next state (s′), sampled action (a), and the data distribution (v_dist)

Actor outputs a recurred action (a_recurred) from the reversed state (s_reversed) and the data distribution (v_dist), and outputs a inferred action (a_inferred) from the sampled state(s) and the data distribution (v_dist)

What is claimed is:

1. A method for reinforcement learning of neural networks, comprising:
a cooperative network configured to receive a sample of transition data, consisting of a state, action, reward, and the next state of an agent within an environment, and to learn a policy and value function that control a transition from a future state to its prior state, implemented through neural networks of a Critic, an Actor, and a Reverse-environment, wherein:
the Critic estimates a value of a sampled state and transmits the estimated value to the Actor and Reverse-environment;
the Actor infers an action, from the sampled state and the estimated value, and transmits the inferred action to the Reverse-environment; and
the Reverse-environment outputs a state that is recurred, from the sampled next state based on the inferred action and the estimated value, and outputs a state that is reversed from the sampled next state based on a sampled action and the estimated value,
wherein costs associated with the forward, reverse, and recurrent transitions, between the sampled state and the next state, are calculated based on a discrepancy among the sampled state, the reversed state, and the recurred state, and
wherein an error within the cooperative network is derived from a combination of the forward, reverse, and recurrent costs.

2. The method of claim 1, wherein:
the transition data is obtained through an exploration of the agent within the environment, and
the actor determines an action for the agent, based on the current state and a value estimate received from the critic.

3. The method of claim 1, wherein:
the forward cost is calculated based on a discrepancy between the recurred state to the reversed state;
the reverse cost is calculated based on a discrepancy between the reversed state to the sampled state; and
the recurrent cost is calculated based on a discrepancy between the recurred state to the sampled state.

4. The method of claim 3, wherein:
the forward cost is associated with a critic error and/or an actor error in the cooperative network;
the reverse cost is associated with a critic error and/or a reverse-environment error in the cooperative network; and
the recurrent cost is associated with an actor error and/or a reverse-environment error in the cooperative network.

5. The method of claim 4, wherein:
the cooperative critic error is derived from a difference between the sum of the forward and reverse costs, and the recurrent cost; and
the cooperative actor error is derived from a difference between the sum of the recurrent and forward costs, and the reverse cost; and
the cooperative reverse-environment error is derived from a difference between the sum of the reverse and recurrent costs, and the forward cost.

6. The method of claim 1, wherein:
the value difference is calculated as the difference between the expected sum of rewards and the estimated value.

7. The method of claim 6, wherein:
the expected sum of rewards is computed based on a value estimate of the next state and the sampled reward.

8. The method of claim 7, wherein:
the value estimate of the next state is determined by a target network of the critic network and the target network is a slower-updating copy of the critic network.

9. The method of claim 6, wherein:
the value function error is derived by minimizing the value difference.

10. The method of claim 9, wherein:
mean Squared Error (MSE) is employed to minimize the value difference, which is the difference between the expected sum of rewards and the estimated value.

11. The method of claim 5, wherein:
the critic loss is calculated as the sum of the value function error and the cooperative critic error.

12. The method of claim 11, wherein:
the backpropagation of the critic loss computes gradients of the loss function with respect to the parameters of the critic network without being involved in adjusting the actor or the reverse-environment; and the parameters of the critic network are adjusted based on the calculated gradients.

13. The method of claim 5, wherein:
the backpropagation of the cooperative critic error and the value function error computes, respectively, gradients of the error functions with respect to the parameters of the critic network without being involved in adjusting the actor or the reverse-environment; and the parameters of the critic network are adjusted based on the calculated gradients.

14. The method of claim 5, wherein:
the value difference is referred to as the advantage, and the actor loss is calculated by multiplying the advantage with the cooperative actor error.

15. The method of claim 14, wherein:
the backpropagation of the actor loss computes gradients of the loss function with respect to the parameters of the actor network without being involved in adjusting the reverse-environment; and the parameters of the actor network are adjusted based on the calculated gradients.

16. The method of claim 5, wherein:
the backpropagation of the cooperative reverse-environment error computes gradients of the error function with respect to the parameters of the reverse-environment; and
the parameters of the reverse-environment network are adjusted based on the calculated gradients.

17. A method for reinforcement learning of neural networks, comprising:
a cooperative network configured to receive a sample of transition data, consisting of a state, action, reward, and the next state of an agent within an environment, and to learn a policy and value function that control a transition from a future state to its prior state, implemented through neural networks of a Critic, an Actor, and a Reverse-environment, wherein:
the Critic estimates a value of a sampled state and transmits the estimated value to the Actor and Reverse-environment;
the Reverse-environment generates a state that is reversed from the sampled next state based on a sampled action and the estimated value;
the Actor outputs an action that is recurred from the reversed state and the estimated value, and outputs an action that is inferred from the sampled state and the estimated value;
wherein costs associated with the forward, reverse, and recurrent transitions, between the sampled state and the next state, are calculated based on a discrepancy among the sampled action, the inferred action, and the recurred action, and
wherein an error within the cooperative network is derived from combination of the forward, reverse, and recurrent costs.

18. A method for reinforcement learning of neural networks, comprising:
a cooperative network configured to receive a sample of transition data, consisting of a state, action, reward, and the next state of an agent within an environment, and to learn a policy and value function that control a transition from a future state to its prior state, implemented through neural networks of a Critic, an Actor, and a Reverse-environment, wherein:
the Critic estimates a value vector of a sampled state and transmits the data distribution of the value vector to the Actor and Reverse-environment;
the Actor infers an action from the sampled state and the data distribution and transmits the inferred action to the Reverse-environment; and
the Reverse-environment outputs a state that is recurred from the sampled next state based on the inferred action and the data distribution, and outputs a state that is reversed from the sampled next state based on a sampled action and the data distribution,
wherein costs associated with the forward, reverse, and recurrent transitions, between the sampled state and the next state, are calculated based on a discrepancy among the sampled state, the reversed state, and the recurred state, and
wherein an error within the cooperative network is derived from combination of the forward, reverse, and recurrent costs.
